(19) United States
(12) Patent Application Publication
(10) Pub. No.: US 2024/0129847 A1
(43) Pub. Date: Apr. 18, 2024

(54) METHODS AND APPARATUS FOR SELECTING A BASE STATION IN A HETEROGENEOUS NETWORK

(71) Applicant: QUALCOMM Incorporated, San Diego, CA (US)

(72) Inventors: Qiaoyu LI, Beijing (CN); Yu ZHANG, San Diego, CA (US); Chao WEI, Beijing (CN); Hao XU, Beijing (CN)

(21) Appl. No.: 18/277,047

(22) PCT Filed: Apr. 17, 2021
(86) PCT No.: PCT/CN2021/087943

§ 371 Date: Aug. 11, 2023

(51) Int. Cl. H04W 48/20; H04W 64/00; H04W 74/0836; H04W 76/10

(52) U.S. Cl. CPC H04W 48/20; H04W 64/006; H04W 74/0836; H04W 76/10; H04W 84/06

(57) ABSTRACT

Aspects of the present disclosure include methods, apparatuses, and computer readable media for receiving at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, selecting a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and establishing a wireless connection with the selected BS.

### BACKGROUND

Aspects of the present disclosure relate generally to wireless communications, and more particularly, to apparatuses and methods for selecting a base station in a heterogeneous network.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

In a wireless communication network, a user equipment (UE), such as an aircraft, may connect to one or more base stations (BSs). The density of the aircrafts connected to the one or more BSs may vary. For example, when an aircraft is near an airport (e.g., within 10, 20, or 50 miles of the airport), there may be numerous UEs (e.g., more than 20, 50, or 100 aircrafts) connecting to a BS associated with the airport. On the other hand, when the aircraft is en-route from one airport to another (e.g., more than 50, 100, or 200 miles from any airport), there may be few UEs (e.g., fewer than 5, 10, or 20 aircrafts) connecting to a BS not associated with any airport. However, it is unclear how the UE selects which BS to connect to during flight. Therefore, improvements in BS selection may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods by an aircraft user equipment (UE) for receiving at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, selecting a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and establishing a wireless connection with the selected BS.

Other aspects of the present disclosure include an aircraft user equipment (UE) having a memory comprising instructions, a transceiver, and one or more processors operatively coupled with the memory and the transceiver, the one or more processors configured to execute instructions in the memory to receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, select a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and establish a wireless connection with the selected BS.

An aspect of the present disclosure includes an aircraft user equipment (UE) including means for receiving at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, means for selecting a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and means for establishing a wireless connection with the selected BS.

Some aspects of the present disclosure include non-transitory computer readable media having instructions stored therein that, when executed by one or more processors of an aircraft user equipment (UE), cause the one or more processors to receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, select a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and establish a wireless connection with the selected BS.

Aspects of the present disclosure include methods by an aircraft user equipment (UE) for establishing a first connection with a first base station (BS) in a heterogeneous network (HetNet) for uplink transmission, establishing a second connection with a second BS in the HetNet for downlink reception, and computing a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

Other aspects of the present disclosure include an aircraft user equipment (UE) having a memory comprising instructions, a transceiver, and one or more processors operatively coupled with the memory and the transceiver, the one or more processors configured to execute instructions in the memory to establish a first connection with a first base station (BS) in a heterogeneous network (HetNet) for uplink transmission, establish a second connection with a second BS in the HetNet for downlink reception, and compute a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

An aspect of the present disclosure includes an aircraft user equipment (UE) including means for establishing a first connection with a first base station (BS) in a heterogeneous network (HetNet) for uplink transmission, means for establishing a second connection with a second BS in the HetNet for downlink reception, and means for computing a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

Some aspects of the present disclosure include non-transitory computer readable media having instructions stored therein that, when executed by one or more processors of an aircraft user equipment (UE), cause the one or more processors to establish a first connection with a first base station (BS) in a heterogeneous network (HetNet) for uplink transmission, establish a second connection with a second BS in the HetNet for downlink reception, and compute a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network according to aspects of the present disclosure;

FIG. 2 is a schematic diagram of an example of a user equipment according to aspects of the present disclosure;

FIG. 3 is a schematic diagram of an example of a base station according to aspects of the present disclosure;

FIG. 4 illustrates an example environment for wireless communications of aircrafts according to aspects of the present disclosure;

FIG. 5 illustrates an example of throughput requirements for air-to-ground communications according to aspects of the present disclosure;

FIGS. 6A-C illustrate examples of channel measurements of power delay profiles according to aspects of the present disclosure;

FIG. 7 illustrates an example environment for selecting base station by an aircraft UE according to aspects of the present disclosure;

FIG. 8 illustrates an example environment for decoupling uplink-downlink heterogeneous network access according to aspects of the present disclosure;

FIG. 9 illustrates an example of an environment for determining timing advance based on the time-domain synchronization technique for decoupled uplink-downlink heterogeneous network access according to aspects of the present disclosure;

FIG. 10 illustrates an example of a method of selecting a base station in a heterogeneous network according to aspects of the present disclosure; and

FIG. 11 illustrates an example of a method for computing time advance of a UE in a decoupled uplink/downlink heterogeneous network according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In certain aspects of the present disclosure, a user equipment (UE) on an aircraft (also known as an aircraft UE) may select one or more base stations for uplink (UL) and/or downlink (DL) communications. As the aircraft approaches an airport, the aircraft may determine whether to connect to a base station proximal to the airport (e.g., within a threshold distance), or another base station remote to the airport (e.g., beyond the threshold distance). The aircraft may determine based on altitudes and/or geographic coordinates of the aircraft and/or the base stations, the projected trajectory of the aircraft, and/or preferences of the base stations. In some aspects, the aircraft may transmit uplink information to the base station remote to the airport and receive downlink information from the base station proximal to the airport.

In one instance, in air-to-ground (ATG) communication, frequency division multiplex (FDM) or time division multiplex (TDM) schemes may be utilized. In some instances, large inter-site distance (ISD) (e.g., 100 kilometers (km) to 200 km) and/or large coverage range (e.g., 300 km cell coverage range) may be deployed to reduce deployment cost. However, when an aircraft is above sea level, the distance between the plane and a nearest BS may be more than 200 km (e.g., up to 300 km). Therefore, it may be desirable for an ATG network to provide up to 300 km of cell coverage.

One challenge with regard to ATG communications is that some systems may utilize non-disjoint operators proprietary frequencies to deploy ATG and/or terrestrial networks. In other words, operators may be interested to adopt the same frequency for deploying both ATG and terrestrial networks to save frequency resource cost, however, in such a scenario, interference among ATG and the terrestrial networks may be non-negligible. Further, on-board ATG terminals may have higher transmission power and/or antenna gain than terrestrial terminals. Therefore, aspects of the present disclosure may address coexistence of ATG and terrestrial networks while maintaining ATG BS/UE core and performance.

Additionally, another challenge in ATG communications is that a large ISD (e.g., 100 km to 200 km in-land or 300 km coastal coverage) may require large timing advances (TAs) to avoid frequent handover and/or inter cell interferences. For example, the TA may be 2 milliseconds (ms) for 300 km coverage. Another challenge in ATG communications is that large Doppler effects (e.g., caused by aircraft flying) may require a large subcarrier spacing (SCS), short coherence time, and/or fast TA-drift. For example, at 1200 kilometer/hour (kmh), a large Doppler effect may be 0.77 kilohertz (kHz) at a carrier frequency of 700 megahertz (MHz), 3.89 kHz at a carrier frequency of 3.5 gigahertz (GHz), or 5.33 kHz at a carrier frequency of 4.8 GHz. When encountering a large Doppler effect, such as ones described above, the SCS may be larger than 7.5 kHz for a 700 MHz carrier frequency, 30 kHz or 60 kHz for a 3.5 GHz carrier frequency, and/or 600 kHz for a 4.8 GHz carrier frequency (assuming the receiver can tolerate a maximum line-of-sight (LoS) Doppler of approximately 10% of the SCS.

A further challenge for ATG communications is that, for various propagation scenarios, various cyclic prefix (CP) lengths and/or waveforms may be used. For example, for an en-route aircraft, a highly Rician, distinctive delay may be up to 2.5 km (i.e., 8.33 microseconds (ns)). During climb and descent, and/or taking-off and landing, a Rayleigh delay may be smaller than the delay for an en-route aircraft. For parking/taxiing, the delay may be similar to terrestrial communication.

In some instances, an additional challenge for ATG communications is that large per-cell throughput may be required (e.g., over 1 gigabit per second (Gbps) data rate per aircraft). The throughput may be to support network traffic for an aircraft (e.g., 1.2 Gbps for download (DL) and 600 Mbps for upload (UL)). Further, the density of aircraft may fluctuate (e.g., more than 60 aircraft per 18,000 km²). Yet another challenge in ATG communications is that interference towards terrestrial NR systems may be increased as an aircraft transmission (TX) beam-width becomes larger after 100 km-200 km propagation. Such interference may be highly dynamic and/or non-synchronized, considering dynamic TDD and/or large-propagation-delay effects.

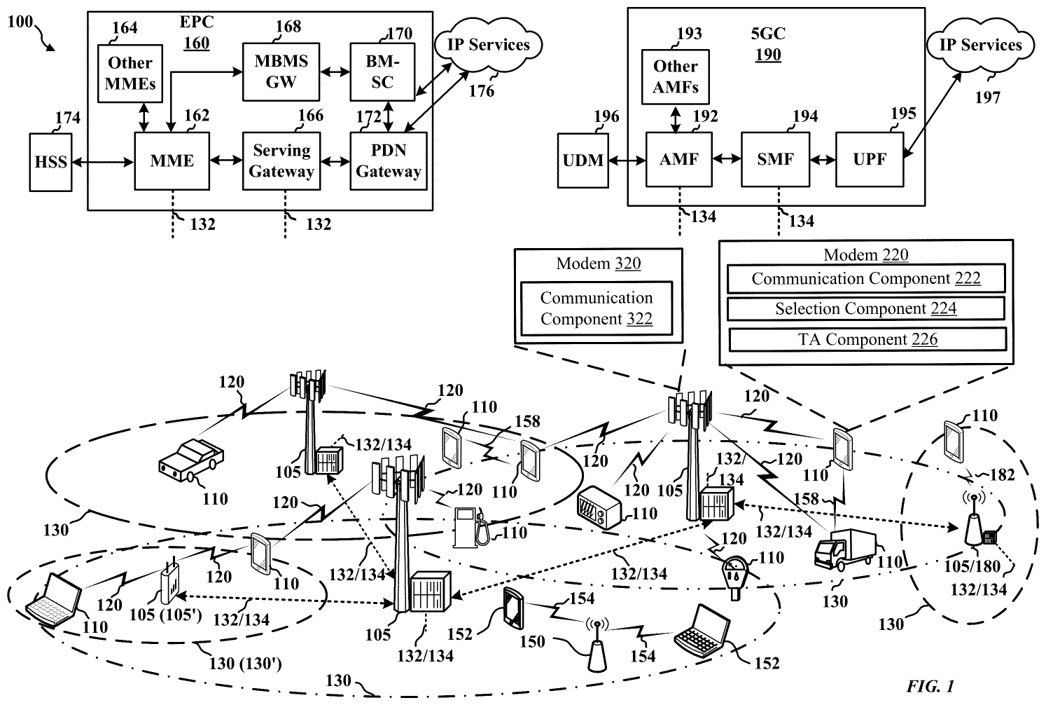

FIG. 1 is a diagram illustrating an example of a wireless communications system and an access network 100. The wireless communications system (also referred to as a wireless wide area network (WWAN)) includes at least one BS 105, UEs 110, an Evolved Packet Core (EPC) 160, and a 5G Core (5GC) 190. The BS 105 may include macro cells (high power cellular base station) and/or small cells (low power cellular base station). The macro cells include base stations. The small cells include femtocells, picocells, and microcells. In one implementation, the UE 110 may include a communication component 222 configured to communicate with the BS 105 via a cellular network, a Wi-Fi network, or other wireless networks. The UE 110 may include a selection component 224 configured to select one or more base stations. The UE 110 may include a TA component 226 configured to compute the TA of the UE 110. In some implementations, the communication component 222, the selection component 224, and/or the TA component 226 may be implemented using hardware, software, or a combination of hardware and software. In some implementations, the BS 105 may include a communication component 322 configured to communicate with the UE 110. In some implementations, the communication component 322 may be implemented using hardware, software, or a combination of hardware and software.

A BS 105 configured for 4G Long-Term Evolution (LTE) (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A BS 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the BS 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The BS 105 may communicate directly or indirectly (e.g., through the EPC 160 or 5GC 190) with each other over the backhaul links interfaces 134. The backhaul links 132, 134 may be wired or wireless.

The BS 105 may wirelessly communicate with the UEs 110. Each of the BS 105 may provide communication coverage for a respective geographic coverage area 130. There may be overlapping geographic coverage areas 130. For example, the small cell 105′ may have a coverage area 130′ that overlaps the coverage area 130 of one or more macro BS 105. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the BS 105 and the UEs 110 may include uplink (UL) (also referred to as reverse link) transmissions from a UE 110 to a BS 105 and/or downlink (DL) (also referred to as forward link) transmissions from a BS 105 to a UE 110. The communication links 120 may use multiple-input and multiple-output (MIMO) antenna technology, including spatial multiplexing, beamforming, and/or transmit diversity. The communication links may be through one or more carriers. The BS 105/UEs 110 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A BS 105, whether a small cell 105′ or a large cell (e.g., macro base station), may include an eNB, gNodeB (gNB), or other type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the BS 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The BS 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The BS 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

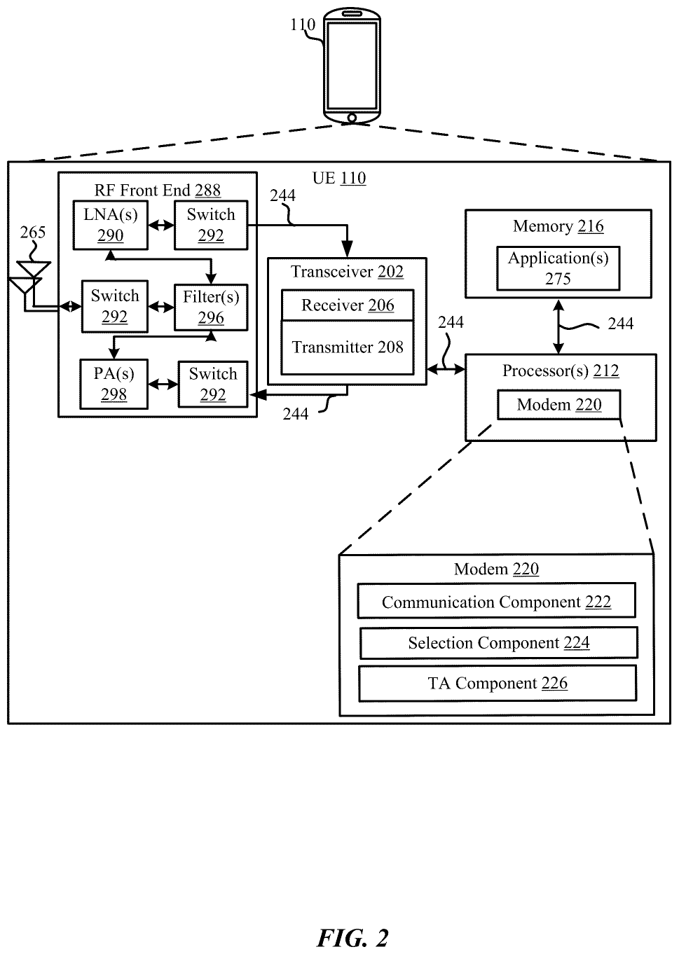

Referring to FIG. 2, one example of an implementation of the UE 110 may include a modem 220 having the communication component 222, the selection component 224, and/or the TA component 226. In one implementation, the UE 110 may include a communication component 222 configured to communicate with the BS 105 via a cellular network, a Wi-Fi network, or other wireless and wired networks. The UE 110 may include a selection component 224 configured to select a base station. The UE 110 may include a TA component 226 configured to compute the TA of the UE 110.

In some implementations, the UE 110 may include a variety of components, including components such as one or more processors 212 and memory 216 and transceiver 202 in communication via one or more buses 244, which may operate in conjunction with the modem 220 and the communication component 222 to enable one or more of the functions described herein related to communicating with the BS 105. Further, the one or more processors 212, modem 220, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 220 that uses one or more modem processors. The various functions related to the communication component 222, the selection component 224, and/or the TA component 226 may be included in the modem 220 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 220 may configure the UE 110 along with the processors 212. In other aspects, some of the features of the one or more processors 212 and/or the modem 220 associated with the communication component 222 may be performed by transceiver 202.

The memory 216 may be configured to store data used and/or local versions of application 275. Also, the memory 216 may be configured to store data used herein and/or local versions of the communication component 222, the selection component 224, and/or the TA component 226, and/or one or more of the subcomponents being executed by at least one processor 212. Memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the communication component 222, the selection component 224, and/or the TA component 226, and/or one or more of the subcomponents, and/or data associated therewith, when UE 110 is operating at least one processor 212 to execute the communication component 222, the selection component 224, and/or the TA component 226, and/or one or more of the subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a RF receiving device. In an aspect, the receiver 206 may receive signals transmitted by at least one BS 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one BS 105 or wireless transmissions transmitted by UE 110. RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more BS 105 or one or more cells associated with one or more BS 105. In an aspect, for example, the modem 220 may configure transceiver 202 to operate at a specified frequency and power level based on the UE configuration of the UE 110 and the communication protocol used by the modem 220.

In an aspect, the modem 220 may be a multiband-multimode modem, which may process digital data and communicate with transceiver 202 such that the digital data is sent and received using transceiver 202. In an aspect, the modem 220 may be multiband and be configured to support multiple frequency bands for a specific communications protocol. In an aspect, the modem 220 may be multimode and be configured to support multiple operating networks and communications protocols. In an aspect, the modem 220 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network.

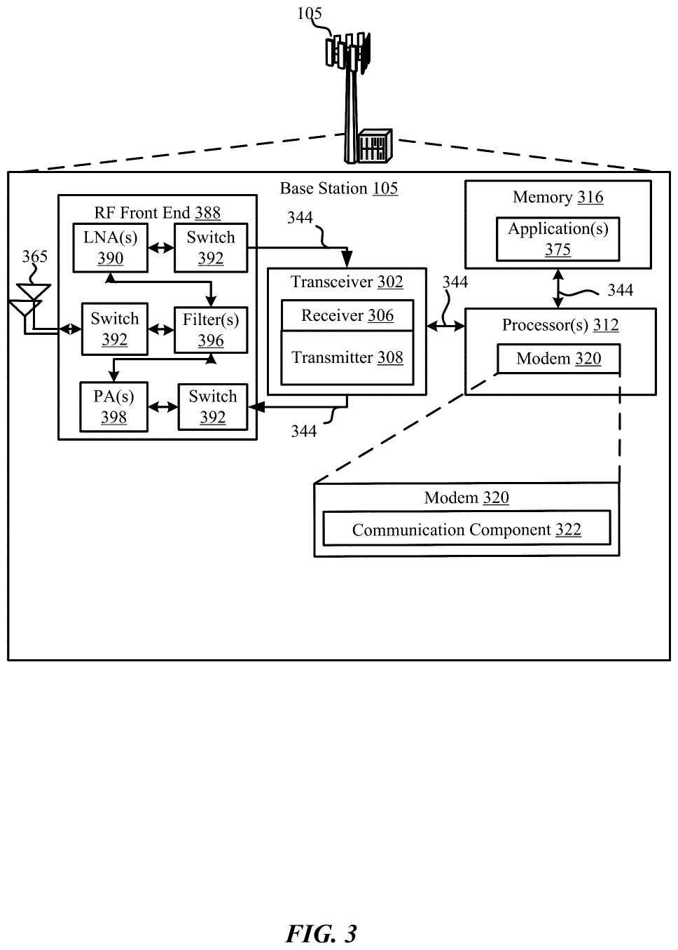

Referring to FIG. 3, one example of an implementation of the BS 105 may include a modem 320 having the communication component 322. In some implementations, the BS 105 may include a communication component 322 configured to communicate with the UE 110.

In some implementations, the BS 105 may include a variety of components, including components such as one or more processors 312 and memory 316 and transceiver 302 in communication via one or more buses 344, which may operate in conjunction with the modem 320 and the communication component 322 to enable one or more of the functions described herein related to communicating with the UE 110. Further, the one or more processors 312, modem 320, memory 316, transceiver 302, RF front end 388 and one or more antennas 365, may be configured to support voice and/or data calls (simultaneously or non-simultaneously) in one or more radio access technologies.

In an aspect, the one or more processors 312 may include the modem 320 that uses one or more modem processors. The various functions related to the communication component 322 may be included in the modem 320 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with transceiver 302. Additionally, the modem 320 may configure the BS 105 and processors 312. In other aspects, some of the features of the one or more processors 312 and/or the modem 320 associated with the communication component 322 may be performed by transceiver 302.

The memory 316 may be configured to store data used herein and/or local versions of applications 375. Also, the memory 316 may be configured to store data used herein and/or local versions of the communication component 322, and/or one or more of the subcomponents being executed by at least one processor 312. Memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the communication component 322, and/or one or more of the subcomponents, and/or data associated therewith, when the BS 105 is operating at least one processor 312 to execute the communication component 322, and/or one or more of the subcomponents.

Transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, a RF receiving device. In an aspect, receiver 306 may receive signals transmitted by the UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the BS 105 may include RF front end 388, which may operate in communication with one or more antennas 365 and transceiver 302 for receiving and transmitting radio transmissions, for example, wireless communications transmitted by other BS 105 or wireless transmissions transmitted by UE 110. RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that BS 105 may communicate with, for example, the UE 110 or one or more cells associated with one or more BS 105. In an aspect, for example, the modem 320 may configure transceiver 302 to operate at a specified frequency and power level based on the base station configuration of the BS 105 and the communication protocol used by the modem 320.

In an aspect, the modem 320 may be a multiband-multimode modem, which may process digital data and communicate with transceiver 302 such that the digital data is sent and received using transceiver 302. In an aspect, the modem 320 may be multiband and be configured to support multiple frequency bands for a specific communications protocol. In an aspect, the modem 320 may be multimode and be configured to support multiple operating networks and communications protocols. In an aspect, the modem 320 may control one or more components of the BS 105 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration associated with the BS 105.

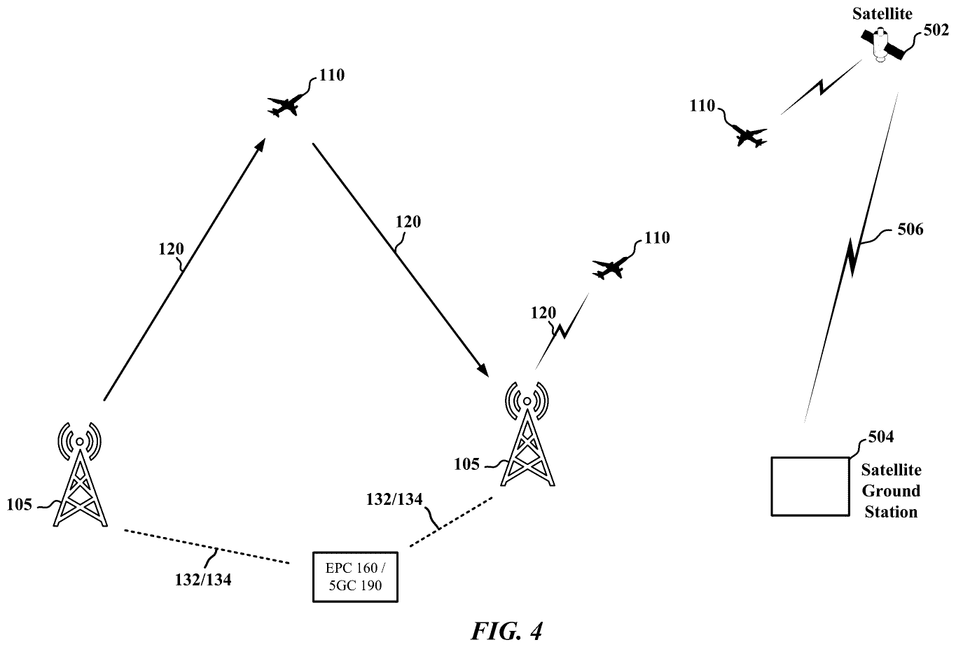

FIG. 4 illustrates an example environment for wireless communications of aircrafts. In some aspects of the present disclosure, commercial passenger aircrafts may provide uplink/downlink communications for passengers for, as examples, entertainments, video and/or audio calls, and/or broadband internet. Further, the aircrafts may rely on wireless communications with air traffic control, cabin crews, and/or airliners. Wireless communications between the UEs 110 and the BSs 105 may be realized with lower deployment costs, while achieving higher throughputs and/or lower latency when compared to satellite communications 506 based on satellites 502 and/or satellite ground stations 504.

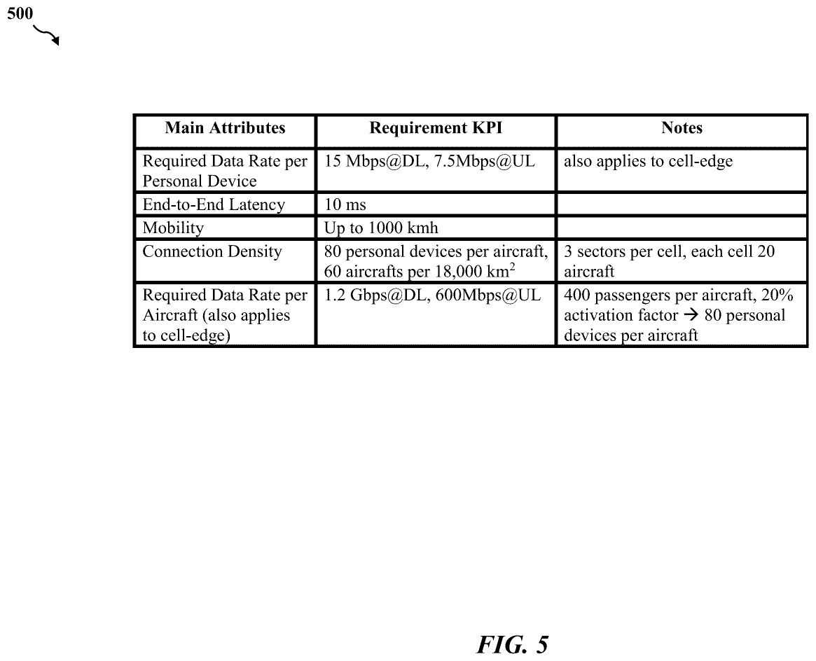

FIG. 5 illustrates an example of throughput requirements for air-to-ground communications. For example, as shown in a table 500, a personal device may be allocated 15 megabits per second (Mbps) for downlink and 7.5 Mbps for uplink. In an aircraft with 400 passengers and a 20% activation factor, each aircraft may require 1.2 gigabits per second (Gbps) for downlink and 600 Mbps for uplink. In an area of 18,000 kilometer square (km²), there may be 60 aircrafts. If there are 3 cells in the area of 18,000 km², each cell may be connected to 20 aircrafts, and may support 24 Gbps of downlink information and 12 Gbps of uplink information.

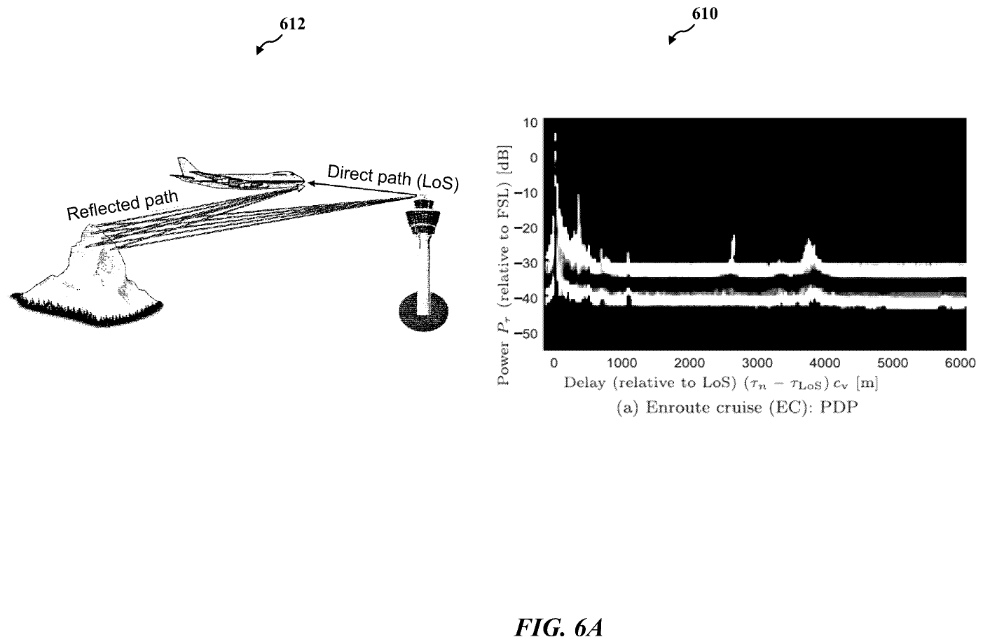

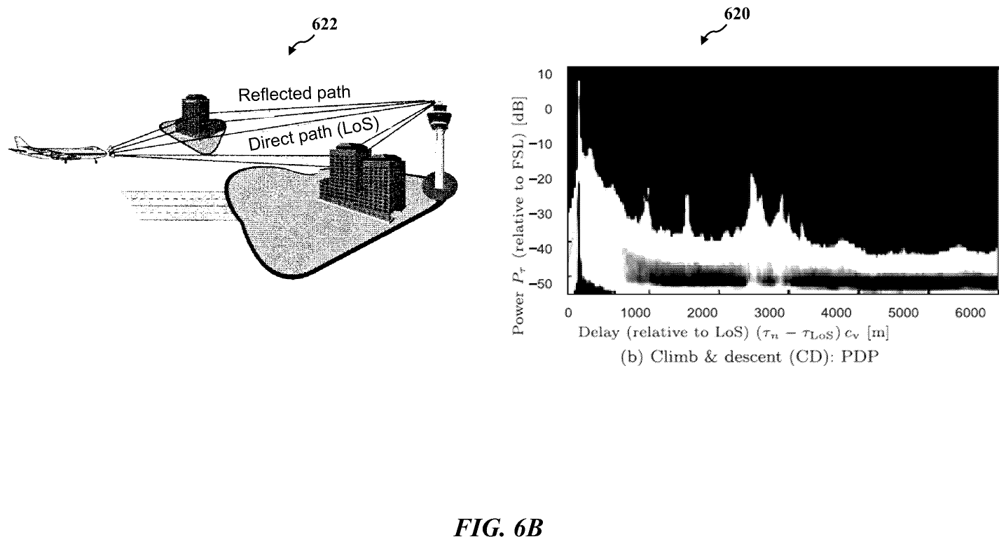

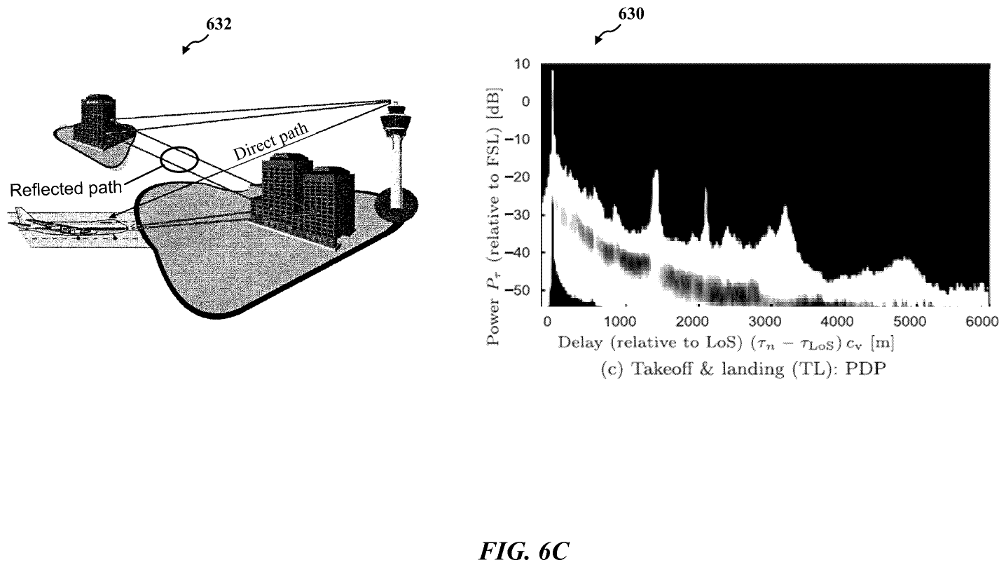

FIGS. 6A-C illustrate examples of channel measurements of power delay profiles. In some instances, the delay (e.g., due to mountains) may be greater than 8 μs, and the CP length may be greater than the delay. For example, at 1200 kilometer/hour (kmh), a large Doppler effect may be 0.77 kilohertz (kHz) at a carrier frequency of 700 megahertz (MHz), 3.89 kHz at a carrier frequency of 3.5 gigahertz (GHz), or 5.33 kHz at a carrier frequency of 4.8 GHz. When encountering a large Doppler effect, such as ones described above, the SCS may be larger than 7.5 kHz for a 700 MHz carrier frequency, 30 kHz or 60 kHz for a 3.5 GHz carrier frequency, and/or 600 kHz for a 4.8 GHz carrier frequency (assuming the receiver can tolerate a maximum line-of-sight (LoS) Doppler of approximately 10% of the SCS. A power delay profile (PDP) graph 610 may illustrate the PDP of an aircraft en-route 612. A PDP graph 620 may illustrate the PDP of an aircraft taking-off and/or landing 622. A PDP graph 630 may illustrate the PDP of an aircraft taxing 632.

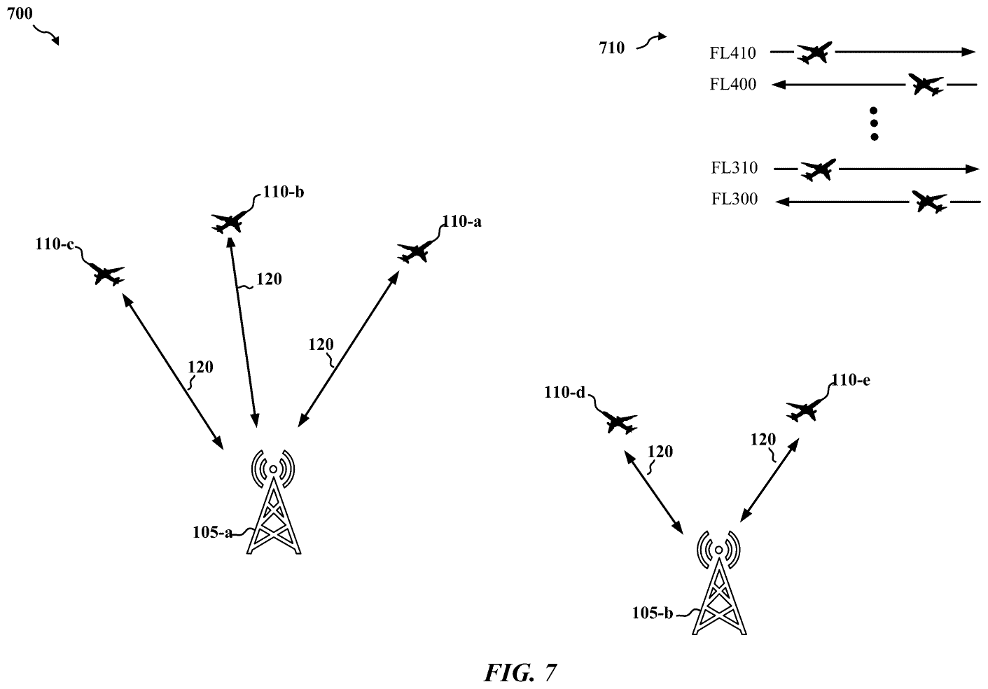

FIG. 7 illustrates an example environment for selecting one or more base stations by an aircraft UE. In certain aspects of the present disclosure, the density of aircrafts may vary across different airspaces. In some instances, aircraft density could be sparse or dense in en-route airspace (e.g., airspace above a threshold distance away from any airport) depending on traffic and/or flight levels (FLs). For vertical separations, multiple aircrafts may pass each other closely in adjacent FLs (e.g., 1000 feet), as shown in a diagram 710 illustrating Reduced Vertical Separation Minima (RVSM). For horizontal separations, aircrafts may be separated by 3 (“terminal”) or 5 (“en-route”) nautical miles (NM) at the same FL. Terminal airspace may indicate airspace within the threshold distance from any airport. In terminal airspace, the density of aircrafts may be higher than that of en-route airspace, with lower FLs. (1 to 3 km, or FL010-FL100). As a result, throughput requirement may be higher around terminal airspace, especially for “busy” terminals (e.g., Peking/John F. Kennedy/London Heathrow). A challenge may be covering both en-route and terminal airpace with a single base station because FLs for both types of airspaces may be different (from a few hundred meters to 10 km), aircrafts may horizontally overlap, and/or there may be more aircrafts in lower FLs.

An aspect of the present disclosure includes using heterogeneous networks (en-route cell and/or terminal cell) to separately cover en-route aircraft and climb/descent aircraft. An aircraft UE may be identified to access a base station (from multiple accessible BSs) for initial access or mobility depending on at least one of: acquired GNSS information and FL information of the aircraft UE, predicted trajectory of the aircraft UE, GNSS coordinates and/or altitudes of the BSs, and/or other information associated with the aircraft UE GNSS-coordinates and FL information preferred by the BSs. In some instances, at least some of the information above may be obtained by the aircraft UE via system information, MsgB or Msg2 during 2-step/4-step random access channel (RACH) procedures, and/or a database associating BSs (e.g., BS tag ID) and their respective information. The selection of the BS may be implemented at the network via automatic dependent surveillance-broadcast (ADS-B). In one aspect, UE initiated approach may lower potential signaling overhead and delays in acquiring locations and/or trajectories.

In an example, an environment 700 may include an en-route BS 105-a and a terminal BS 105-b. The en-route BS 105-a may be more than a threshold distance (e.g., 60 km) away from an airport (not shown). The terminal BS 105-b may be within the threshold distance from the airport. The environment 700 may include a first aircraft UE 110-a, a second aircraft UE 110-b, a third aircraft UE 110-c, a fourth aircraft UE 110-d, and a fifth aircraft UE 110-e. The first aircraft UE 110-a may obtain FL information (e.g., altitude of 10 km or FL310) from an on-board altimeter. Based on the altitude, the first aircraft UE 110-a may select, via the selection component 224, the en-route BS 105-a for connection. The second aircraft UE 110-b may obtain GNSS coordinates of the second aircraft UE 110-b from a satellite (not shown) and/or GNSS coordinates of the en-route BS 105-a. Based on the GNSS coordinates of the second aircraft UE 110-b and/or the en-route BS 105-a (e.g., the second aircraft UE 110-b is 50 km from the en-route BS 105-a), the second aircraft UE 110-b may select, via the selection component 224, the en-route BS 105-a for connection. The third aircraft UE 110-c may receive a preference of the en-route BS 105-a via system information transmitted by the en-route BS 105-a. Based on the system information, the third aircraft UE 110-c may select, via the selection component 224, the en-route BS 105-a for connection.

In some implementations, the fourth aircraft UE 110-d may obtain the predicted trajectory of the fourth aircraft UE 110-d (e.g., the fourth aircraft UE 110-d is preparing to land at the airport within the threshold distance from the terminal BS 105-b). Based on the predicted trajectory, the fourth aircraft UE 110-d may select, via the selection component 224, the terminal BS 105-b for connection. The fifth aircraft UE 110-e may obtain GNSS coordinates of the fifth aircraft UE 110-e from a satellite (e.g., the fifth aircraft UE 110-e is taxiing in the airport within the threshold distance from the terminal BS 105-b). Based on the GNSS coordinates of the fifth aircraft UE 110-e, the fifth aircraft UE 110-e may select, via the selection component 224, the terminal BS 105-b for connection. After the UEs 110 determine the selected BS 105 for connection, the UEs 110 may establish one or more connections with the selected BS 105 using the communication component 222.

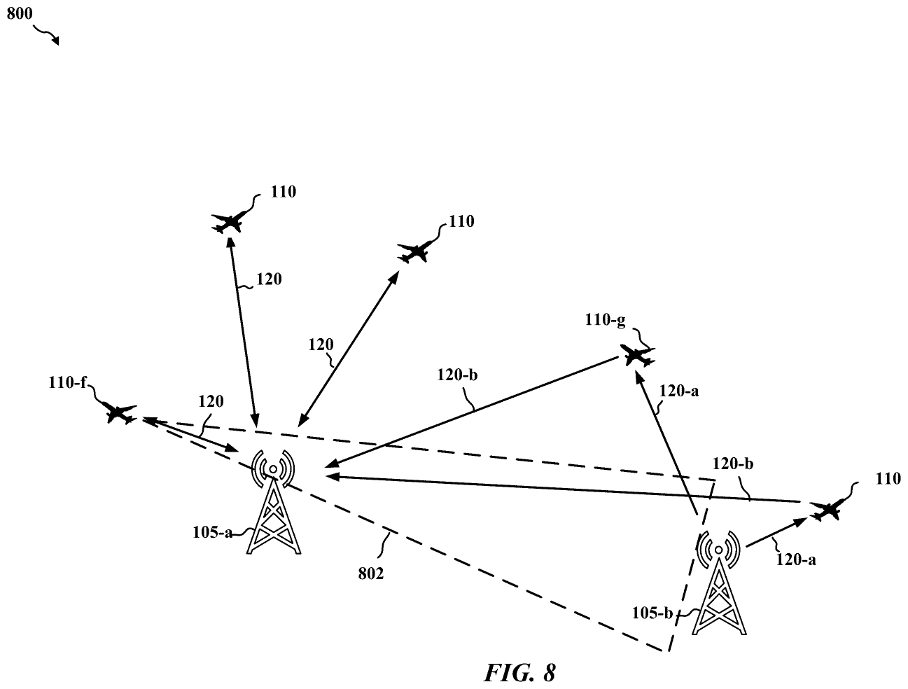

FIG. 8 illustrates an example environment for decoupling uplink-downlink heterogeneous network access. In an aspect of the present disclosure, an aircraft UE may be configured to receive downlink signals (e.g., DL reference signals (RS), physical downlink control channel (PDCCH), and/or physical downlink shared channel (PDSCH)) from a first BS. The aircraft UE may be configured to transmit uplink signals (e.g., UL RS, physical uplink control channel (PUCCH), and/or physical uplink shared channel (PUSCH)) toward a second BS. The aircraft UE may identify each of the BSs via techniques described above, and/or via network configurations transmitted to the aircraft UE. Decoupling uplink-downlink access may reduce and/or prevent interference from aircraft UEs with high FLs (e.g., 10 km) toward terminal cells/BSs UL reception due to lower UL throughput requirements and/or the beams of aircraft UEs (at high FLs) may expand after propagation.

In an example, an environment 800 may include the en-route BS 105-a and the terminal BS 105-b. The en-route BS 105-a may be more than the threshold distance (e.g., 60 km) away from an airport (not shown). The terminal BS 105-b may be within the threshold distance from the airport. The environment 800 may include a sixth aircraft UE 110-f, a seventh aircraft UE 110-g, and other aircraft UEs 110. The sixth aircraft UE 110-f may be connected to the en-route BS 105-a. The seventh aircraft UE 110-g may be connected to the en-route BS 105-a and the terminal BS 105-b. Specifically, the seventh aircraft UE 110-g may transmit uplink information via an uplink communication link 120-b and receive downlink information via a downlink communication link 120-a.

When transmitting uplink information toward the en-route BS 105-a, uplink transmission beams 802 from the sixth aircraft UE 110-f may propagate toward the terminal BS 105-b. However, since the terminal BS 105-b provides downlink transmission, and receive no uplink transmission, the uplink transmission beams 802 may not interference (or reduce the interference) with the operation of the terminal BS 105-b.

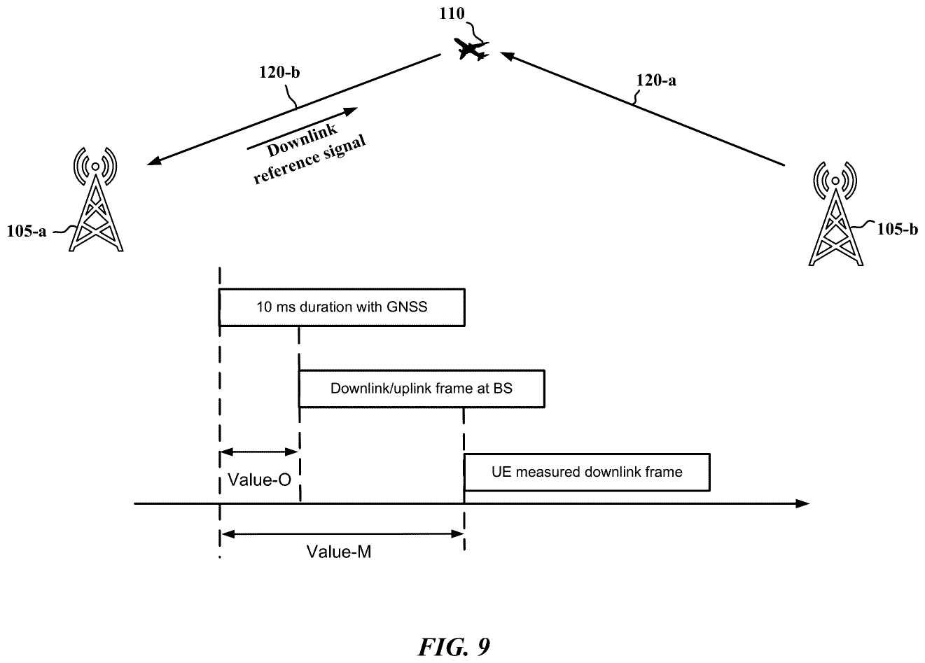

FIG. 9 illustrates an example of an environment for determining timing advance based on the time-domain synchronization technique for decoupled uplink-downlink heterogeneous network access. Due to aircraft UE continuously motion during flight, UE-specific medium access control (MAC) control element (CE) timing advance (TA) command may be sent repeatedly, leading to an increase in overhead. For example, at 1200 km/h of flight speed, TA drafting may be up to 2 μs/second. OCI-based TA-command may also increase overhead. An advantage in UE autonomously compensating for TA may decrease overhead. Satellite ephemeris information may be potentially predefined, or obtained from system information. In ATG communications, BSs are fixed on the ground, and satellite ephemeris information may be replaced with other location and/or time-domain (TD) synchronized information.

In one aspect, the UE may perform TA compensation by computing TA based on the GNSS information of the UE and the GNSS information of the BS, including the BS coordinates and/or TD synchronization information. In some aspects, the TA drifting rate signaling may be based on UE trajectory predicted by the BS.

In some aspects, the aircraft UE may compensate for UL TA based on the coordinates and/or altitudes of the aircraft UE (provided by GNSS equipment and/or altimeters) and the coordinates and/or altitudes of the BS. By computing the distance between the aircraft UE and the BS, the aircraft UE may calculate the propagation time between the aircraft UE and the BS by dividing the distance by the speed of light. The propagation time may be used to compute the TA (may be identical). The BS coordinates may be identified from system information, MsgB of a 2-step random access channel (RACH) procedure, Msg2 of a 4-step RACh procedure, or a database associated the BS (e.g., BS ID) and its coordinates/altitudes.

In one aspect of the present disclosure, the aircraft UE may synchronize with the GNSS. The aircraft UE may identify a first GNSS frame offset (“Value-O”), which is the measured difference between the DL frame of the BS and the starting point of the GNSS. The aircraft UE may identify a second GNSS frame offset (“Value-M”), which is a measured difference between the UE measured DL frame and the starting point of the GNSS. At least one of the first GNSS frame offset and/or the second GNSS frame offset may be identified from system information and/or a database associated the BS (e.g., BS ID) and the associated first GNSS frame offset and/or the second GNSS frame offset. The starting point of the GNSS may also be signaled.

In another aspect of the present disclosure, the BS may periodically or aperiodically signal the aircraft UE TA drifting rate information based on at least one of predicted UE trajectory, UE location, UE speed, and/or automatic dependent surveillance-broadcast (ADS-B). The aircraft UE may use the TA drifting rate and other TA commands for TA compensation.

In an aspect of the present disclosure, the aircraft UE may be communicatively coupled to a first BS for downlink transmission and a second BS for uplink transmission. The aircraft UE may determine the TA based on the GNSS, the first GNSS offset, the second GNSS offset, the aircraft UE offset with the GNSS, and/or an offset between the uplink frame and the downlink frame of the second BS (as described above).

In another aspect of the present disclosure, the second BS may transmit downlink reference signals. The aircraft UE may determine the TA based on the GNSS, the first GNSS offset, the second GNSS offset (between the GNSS and the measured downlink reference signals), the aircraft UE offset with the GNSS, and/or an offset between the uplink frame and the downlink frame of the first BS. In some cases, the aircraft UE may receive configurations indicating certain downlink reference signals for determining uplink frame starting point. The downlink signals may be a separate synchronization signal block or a separate channel state information reference signal having different timing relationships with current active downlink bandwidth part. The configuration information may be obtained via system information, Msg2/MsgB, and/or a database as indicated above.

In certain implementations, due to different propagation profiles associated with different uplink-downlink BSs, waveforms and/or numerologies may be configured for the aircraft UE separately in uplink and/or downlink. For example, the aircraft UE may be configured to operate frequency division duplex (FDD) and/or time division duplex (TDD) within a certain component carrier. In downlink, the aircraft UE may be configured with OFDM waveform, and in uplink the aircraft UE may be configured with OTFS waveform. The aircraft UE may be configured to operate FDD/TDD within a certain BWP. In DL, the aircraft UE may be configured with SCS=60 kHz and CP-length=1.17 μs (14-syms per slot), while in UL, the aircraft UE may be configured with SCS=60 kHz and CP-length=8.32 μs (10-syms per slot). When operating in TDD, further gap time may be identified (predefined or configured) between downlink and uplink durations to improve time-domain alignment.

In an aspect of the present disclosure, the aircraft UE may determine the TA based on the GNSS information (e.g., coordinates/altitude) of the first BS, the GNSS information (e.g., coordinates/altitudes) of the second BS, the GNSS information of the aircraft UE, and any fixed or configured offset between the uplink frames and the downlink frames of the second BS. The offset may be obtained from the first BS and/or the second BS.

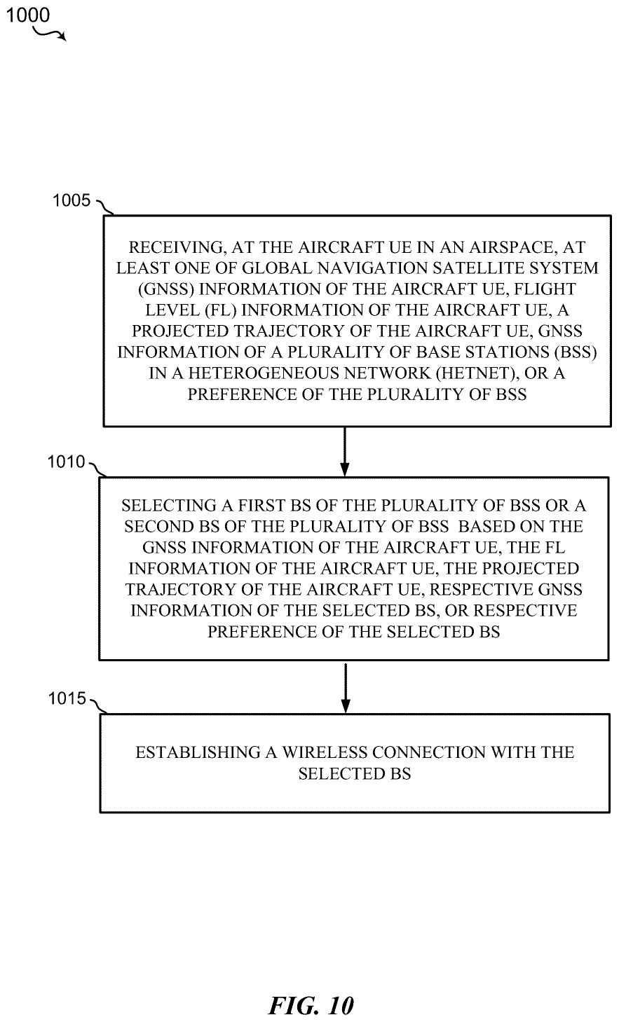

FIG. 10 illustrates an example of a method of selecting a base station in a heterogeneous network. For example, a method 1000 may be performed by the one or more of the processor 212, the memory 216, the applications 275, the modem 220, the transceiver 202, the receiver 206, the transmitter 208, the RF front end 288, the communication component 222 and/or the selection component 224, and/or one or more other components of the UE 110 in the wireless communication network 100.

At block 1005, the method 1000 may receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs as described above. The RF front end 288 may receive the electrical signals converted from electro-magnetic signals. The RF front end 288 may filter and/or amplify the electrical signals. The transceiver 202 or the receiver 206 may convert the electrical signals to digital signals, and send the digital signals to the communication component 222.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for receiving at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs.

At block 1010, the method 1000 may select a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS. For example, the selection component 224, the processor 212, the memory 216, the modem 220, and/or the applications 275 of the UE 110 may select a first BS (such as the terminal BS 105-b) of the plurality of BSs or a second BS (such as the en-route BS 105-a) of the plurality of BSs based on the GNSS information of the aircraft UE, the FL information of the aircraft UE, the projected trajectory of the aircraft UE, respective GNSS information of the selected BS, or a respective coverage preference of the selected BS as described above.

In certain implementations, the selection component 224, the processor 212, the memory 216, the modem 220, and/or the applications 275 may be configured to and/or may define means for selecting a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS.

At block 1015, the method 1000 may establish a wireless connection with the selected BS. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may establish a wireless connection with the selected BS. During the reception process, the RF front end 288 may receive the electrical signals converted from electro-magnetic signals. The RF front end 288 may filter and/or amplify the electrical signals. The transceiver 202 or the receiver 206 may convert the electrical signals to digital signals, and send the digital signals to the communication component 222. During the transmission process, the communication component 222 may send the digital signals to the transceiver 202 or the transmitter 208. The transceiver 202 or the transmitter 208 may convert the digital signals to electrical signals and send to the RF front end 288. The RF front end 288 may filter and/or amplify the electrical signals. The RF front end 288 may send the electrical signals as electro-magnetic signals via the one or more antennas 265.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for establishing a wireless connection with the selected BS.

Alternatively or additionally, the method 1000 may further include any of the methods above, wherein receiving further comprising receiving the GNSS information of the plurality of BSs or a preference of the plurality of BSs via system information.

Alternatively or additionally, the method 1000 may further include any of the methods above, wherein receiving further comprises receiving the GNSS information of the plurality of BS s or a preference of the plurality of BS s via a MSG-B of a 2-step random access channel (RACH) procedure or a MSG-2 of a 4-step RACH procedure.

Alternatively or additionally, the method 1000 may further include any of the methods above, wherein receiving further comprises obtaining the GNSS information of the plurality of BSs or a preference of the plurality of BSs from a database associating one or more identifiers of the plurality of BSs and at least one of the respective GNSS information of the selected BS, or the respective preference of the selected BS.

Alternatively or additionally, the method 1000 may further include any of the methods above, wherein the FL information is obtained from an altimeter of the aircraft UE.

Alternatively or additionally, the method 1000 may further include any of the methods above, wherein the GNSS information of the plurality of BSs comprises geographic coordinates of the plurality of BSs or altitudes of the plurality of BSs.

Alternatively or additionally, the method 1000 may further include any of the methods above, wherein the preference comprises a threshold range for the aircraft UE to establish the wireless connection with the selected BS.

Alternatively or additionally, the method 1000 may further include any of the methods above, wherein the coverage preferences include at least one of GNSS coordinates or flight levels covered by at least one BS of the plurality of BSs.

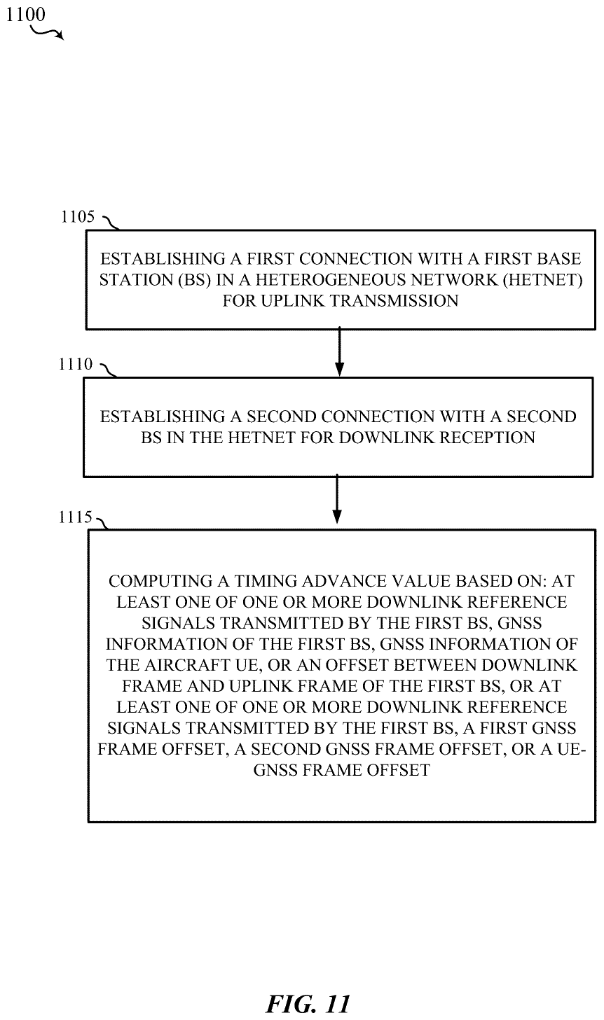

FIG. 11 illustrates an example of a method for computing time advance of a UE in a decoupled uplink/downlink heterogeneous network. For example, a method 1100 may be performed by the one or more of the processor 212, the memory 216, the applications 275, the modem 220, the transceiver 202, the receiver 206, the transmitter 208, the RF front end 288, the communication component 222, the selection component 224, and/or the TA component 226, and/or one or more other components of the UE 110 in the wireless communication network 100.

At block 1105, the method 1100 may establish a first connection with a first base station (BS) in a heterogeneous network (HetNet) for uplink transmission. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may establish a first connection with a first base station (BS) in a heterogeneous network (HetNet) for uplink transmission as described above.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for establishing a first connection with a first base station (BS) in a heterogeneous network (HetNet) for uplink transmission.

At block 1110, the method 1100 may establish a second connection with a second BS in the HetNet for downlink reception. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may establish a second connection with a second BS in the HetNet for downlink reception as described above.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for establishing a second connection with a second BS in the HetNet for downlink reception.

At block 1115, the method 1100 may compute a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset. For example, the TA component 226, the processor 212, the memory 216, the modem 220, and/or the applications 275 of the UE 110 may compute a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

In certain implementations, the TA component 226, the processor 212, the memory 216, the modem 220, and/or the applications 275 may be configured to and/or may define means for computing a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

Alternatively or additionally, the method 1100 may further include any of the methods above, further comprising, prior to establishing the first connection and the second connection receiving, at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or a preference of the plurality of BSs, and selecting the first BS and the second BS of the plurality of BSs or a second BS of the plurality of BSs based on the GNSS information of the aircraft UE, the FL information of the aircraft UE, the projected trajectory of the aircraft UE, respective GNSS information of the selected BS, or respective preferences of the selected BSs.

Alternatively or additionally, the method 1100 may further include any of the methods above, further comprising receiving configuration information indicating the first BS for the uplink transmission and the second BS for the downlink transmission.

Alternatively or additionally, the method 1100 may further include any of the methods above, further comprising receiving configuration information indicating a starting frame of the uplink frame relative to at least one of the one or more downlink reference signals

Additional Implementations

Aspects of the present disclosure include methods by an user equipment (UE) for receiving at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, selecting a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and establishing a wireless connection with the selected BS.

The method above, wherein receiving further comprising receiving the GNSS information of the plurality of BSs or a preference of the plurality of BSs via system information.

Any of the methods above, wherein receiving further comprising receiving the GNSS information of the plurality of BSs or a preference of the plurality of BSs via a MSG-B of a 2-step random access channel (RACH) procedure or a MSG-2 of a 4-step RACH procedure.

Any of the methods above, wherein receiving further comprising obtaining the GNSS information of the plurality of BSs or a preference of the plurality of BSs from a database associating one or more identifiers of the plurality of BSs and at least one of the respective GNSS information of the selected BS, or the respective preference of the selected BS.

Any of the methods above, wherein the FL information is obtained from an altimeter of the aircraft UE.

Any of the methods above, wherein the GNSS information of the plurality of BSs comprises geographic coordinates of the plurality of BSs or altitudes of the plurality of BSs.

Any of the methods above, wherein the preference comprises a threshold range for the aircraft UE to establish the wireless connection with the selected BS.

Any of the methods above, wherein the coverage preferences include at least one of GNSS coordinates or flight levels covered by at least one BS of the plurality of BSs.

Other aspects of the present disclosure include an aircraft user equipment (UE) having a memory comprising instructions, a transceiver, and one or more processors operatively coupled with the memory and the transceiver, the one or more processors configured to execute instructions in the memory to receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, select a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and establish a wireless connection with the selected BS.

The aircraft UE above, wherein the one or more processors are further configured to receive the GNSS information of the plurality of BSs or a preference of the plurality of BSs via system information.

Any of the aircraft UEs above, wherein the one or more processors are further configured to receive the GNSS information of the plurality of BSs or a preference of the plurality of BSs via a MSG-B of a 2-step random access channel (RACH) procedure or a MSG-2 of a 4-step RACH procedure.

Any of the aircraft UEs above, wherein the one or more processors are further configured to obtain the GNSS information of the plurality of BSs or a preference of the plurality of BSs from a database associating one or more identifiers of the plurality of BSs and at least one of the respective GNSS information of the selected BS, or the respective preference of the selected BS.

Any of the aircraft UEs above, wherein the FL information is obtained from an altimeter of the aircraft UE.

Any of the aircraft UEs above, wherein the GNSS information of the plurality of BSs comprises geographic coordinates of the plurality of BSs or altitudes of the plurality of BSs.

Any of the aircraft UEs above, wherein the preference comprises a threshold range for the aircraft UE to establish the wireless connection with the selected BS.

Any of the aircraft UEs above, wherein the coverage preferences include at least one of GNSS coordinates or flight levels covered by at least one BS of the plurality of BSs.

An aspect of the present disclosure includes an aircraft user equipment (UE) including means for receiving at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, means for selecting a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and means for establishing a wireless connection with the selected BS.

The aircraft UE above, wherein means for receiving further comprising means for receiving the GNSS information of the plurality of BSs or a preference of the plurality of BSs via system information.

Any of the aircraft UEs above, wherein means for receiving further comprising means for receiving the GNSS information of the plurality of BSs or a preference of the plurality of BSs via a MSG-B of a 2-step random access channel (RACH) procedure or a MSG-2 of a 4-step RACH procedure.

Any of the aircraft UEs above, wherein means for receiving further comprising means for obtaining the GNSS information of the plurality of BSs or a preference of the plurality of BSs from a database associating one or more identifiers of the plurality of BSs and at least one of the respective GNSS information of the selected BS, or the respective preference of the selected BS.

Any of the aircraft UEs above, wherein the FL information is obtained from an altimeter of the aircraft UE.

Any of the aircraft UEs above, wherein the GNSS information of the plurality of BSs comprises geographic coordinates of the plurality of BSs or altitudes of the plurality of BSs.

Any of the aircraft UEs above, wherein the preference comprises a threshold range for the aircraft UE to establish the wireless connection with the selected BS.

Any of the aircraft UEs above, wherein the coverage preferences include at least one of GNSS coordinates or flight levels covered by at least one BS of the plurality of BSs.

Some aspects of the present disclosure include non-transitory computer readable media having instructions stored therein that, when executed by one or more processors of an aircraft user equipment (UE), cause the one or more processors to receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs, select a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS, and establish a wireless connection with the selected BS.

The non-transitory computer readable medium above, wherein the instructions for receiving further comprising instructions, when executed by the one or more processors, cause the one or more processors to receive the GNSS information of the plurality of BSs or a preference of the plurality of BSs via system information.

Any of the non-transitory computer readable media above, wherein the instructions for receiving further comprising instructions, when executed by the one or more processors, cause the one or more processors to receive the GNSS information of the plurality of BS s or a preference of the plurality of BS s via a MSG-B of a 2-step random access channel (RACH) procedure or a MSG-2 of a 4-step RACH procedure.

Any of the non-transitory computer readable media above, wherein the instructions for receiving further comprising instructions, when executed by the one or more processors, cause the one or more processors to obtain the GNSS information of the plurality of BSs or a preference of the plurality of BSs from a database associating one or more identifiers of the plurality of BSs and at least one of the respective GNSS information of the selected BS, or the respective preference of the selected BS.

Any of the non-transitory computer readable media above, wherein the FL information is obtained from an altimeter of the aircraft UE.

Any of the non-transitory computer readable media above, wherein the GNSS information of the plurality of BSs comprises geographic coordinates of the plurality of BSs or altitudes of the plurality of BSs.

Any of the non-transitory computer readable media above, wherein the preference comprises a threshold range for the aircraft UE to establish the wireless connection with the selected BS.

Any of the non-transitory computer readable media above, wherein the coverage preferences include at least one of GNSS coordinates or flight levels covered by at least one BS of the plurality of BSs.

Aspects of the present disclosure include methods by an aircraft user equipment (UE) for establishing a first connection with a first base station (BS) in a heterogeneous network (HetNet) for uplink transmission, establishing a second connection with a second BS in the HetNet for downlink reception, and computing a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

Aspects of the present disclosure include the method above, further comprising, prior to establishing the first connection and the second connection, receiving, at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or a preference of the plurality of BSs, and selecting the first BS and the second BS of the plurality of BSs or a second BS of the plurality of BSs based on the GNSS information of the aircraft UE, the FL information of the aircraft UE, the projected trajectory of the aircraft UE, respective GNSS information of the selected BS, or respective preferences of the selected BSs.

Aspects of the present disclosure include any of the methods above, further comprising receiving configuration information indicating the first BS for the uplink transmission and the second BS for the downlink transmission.

Aspects of the present disclosure include any of the methods above, further comprising receiving configuration information indicating a starting frame of the uplink frame relative to at least one of the one or more downlink reference signals.

Other aspects of the present disclosure include an aircraft user equipment (UE) having a memory comprising instructions, a transceiver, and one or more processors operatively coupled with the memory and the transceiver, the one or more processors configured to execute instructions in the memory to establish a first connection with a first base station (BS) in a heterogeneous network (HetNet) for uplink transmission, establish a second connection with a second BS in the HetNet for downlink reception, and compute a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

Aspects of the present disclosure include the aircraft UE above, wherein the one or more processors are further configured to, prior to establishing the first connection and the second connection, receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or a preference of the plurality of BSs, and select the first BS and the second BS of the plurality of BSs or a second BS of the plurality of BSs based on the GNSS information of the aircraft UE, the FL information of the aircraft UE, the projected trajectory of the aircraft UE, respective GNSS information of the selected BS, or respective preferences of the selected BSs.

Aspects of the present disclosure include any of the aircraft UEs above, wherein the one or more processors are further configured to receive configuration information indicating the first BS for the uplink transmission and the second BS for the downlink transmission.

Aspects of the present disclosure include any of the aircraft UEs above, wherein the one or more processors are further configured to receive configuration information indicating a starting frame of the uplink frame relative to at least one of the one or more downlink reference signals.

An aspect of the present disclosure includes an aircraft user equipment (UE) including means for establishing a first connection with a first base station (BS) in a heterogeneous network (HetNet) for uplink transmission, means for establishing a second connection with a second BS in the HetNet for downlink reception, and means for computing a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

Aspects of the present disclosure include the aircraft UE above, further comprising, prior to establishing the first connection and the second connection, means for receiving, at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or a preference of the plurality of BSs, and means for selecting the first BS and the second BS of the plurality of BSs or a second BS of the plurality of BSs based on the GNSS information of the aircraft UE, the FL information of the aircraft UE, the projected trajectory of the aircraft UE, respective GNSS information of the selected BS, or respective preferences of the selected BSs.

Aspects of the present disclosure include any of the aircraft UEs above, further comprising means for receiving configuration information indicating the first BS for the uplink transmission and the second BS for the downlink transmission.

Aspects of the present disclosure include any of the aircraft UEs above, further comprising means for receiving configuration information indicating a starting frame of the uplink frame relative to at least one of the one or more downlink reference signals.

Some aspects of the present disclosure include non-transitory computer readable media having instructions stored therein that, when executed by one or more processors of an aircraft user equipment (UE), cause the one or more processors to establish a first connection with a first base station (BS) in a heterogeneous network (HetNet) for uplink transmission, establish a second connection with a second BS in the HetNet for downlink reception, and compute a timing advance value based on: at least one of one or more downlink reference signals transmitted by the first BS, GNSS information of the first BS, GNSS information of the aircraft UE, or an offset between downlink frame and uplink frame of the first BS, or at least one of one or more downlink reference signals transmitted by the first BS, a first GNSS frame offset, a second GNSS frame offset, or a UE-GNSS frame offset.

Aspects of the present disclosure include the non-transitory computer readable medium above, further comprising instructions, when executed by the one or more processors, cause the one or more processors to, prior to establishing the first connection and the second connection, receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or a preference of the plurality of BSs, and select the first BS and the second BS of the plurality of BSs or a second BS of the plurality of BSs based on the GNSS information of the aircraft UE, the FL information of the aircraft UE, the projected trajectory of the aircraft UE, respective GNSS information of the selected BS, or respective preferences of the selected BSs.

Aspects of the present disclosure include any of the non-transitory computer readable media above, further comprising instructions, when executed by the one or more processors, cause the one or more processors to receive configuration information indicating the first BS for the uplink transmission and the second BS for the downlink transmission.

Aspects of the present disclosure include any of the non-transitory computer readable media above, further comprising instructions, when executed by the one or more processors, cause the one or more processors to receive configuration information indicating a starting frame of the uplink frame relative to at least one of the one or more downlink reference signals.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication by an aircraft user equipment (UE) in a network, comprising:
receiving at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs;
selecting a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS; and
establishing a wireless connection with the selected BS.

2. The method of claim 1, wherein receiving further comprising:
receiving the GNSS information of the plurality of BSs or a preference of the plurality of BSs via system information.

3. The method of claim 1, wherein receiving further comprising:
receiving the GNSS information of the plurality of BSs or a preference of the plurality of BSs via a MSG-B of a 2-step random access channel (RACH) procedure or a MSG-2 of a 4-step RACH procedure.

4. The method of claim 1, wherein receiving further comprising:
obtaining the GNSS information of the plurality of BSs or a preference of the plurality of BSs from a database associating one or more identifiers of the plurality of BSs and at least one of the respective GNSS information of the selected BS, or the respective preference of the selected BS.

5. The method of claim 1, wherein:
the FL information is obtained from an altimeter of the aircraft UE.

6. The method of claim 1, wherein:
the GNSS information of the plurality of BSs comprises geographic coordinates of the plurality of BSs or altitudes of the plurality of BSs.

7. The method of claim 1, wherein:
the preference comprises a threshold range for the aircraft UE to establish the wireless connection with the selected BS.

8. The method of claim 1, wherein:
the coverage preferences include at least one of GNSS coordinates or flight levels covered by at least one BS of the plurality of BSs.

9. An aircraft user equipment (UE), comprising:
a memory comprising instructions;
a transceiver; and
one or more processors operatively coupled with the memory and the transceiver, the one or more processors configured to execute instructions in the memory to:
receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs;
select a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS; and
establish a wireless connection with the selected BS.

10. The aircraft UE of claim 9, wherein the one or more processors are further configured to:
receive the GNSS information of the plurality of BSs or a preference of the plurality of BSs via system information.

11. The aircraft UE of claim 9, wherein the one or more processors are further configured to:
receive the GNSS information of the plurality of BSs or a preference of the plurality of BSs via a MSG-B of a 2-step random access channel (RACH) procedure or a MSG-2 of a 4-step RACH procedure.

12. The aircraft UE of claim 9, wherein the one or more processors are further configured to:
obtain the GNSS information of the plurality of BS s or a preference of the plurality of BSs from a database associating one or more identifiers of the plurality of BSs and at least one of the respective GNSS information of the selected BS, or the respective preference of the selected BS.

13. The aircraft UE of claim 9, wherein:
the FL information is obtained from an altimeter of the aircraft UE.

14. The aircraft UE of claim 9, wherein:
the GNSS information of the plurality of BSs comprises geographic coordinates of the plurality of BSs or altitudes of the plurality of BSs.

15. The aircraft UE of claim 9, wherein:
the preference comprises a threshold range for the aircraft UE to establish the wireless connection with the selected BS.

16. The aircraft UE of claim 9, wherein:
the coverage preferences include at least one of GNSS coordinates or flight levels covered by at least one BS of the plurality of BSs.

17. A non-transitory computer readable medium having instructions stored therein that, when executed by one or more processors of an aircraft user equipment (UE), cause the one or more processors to:
receive at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or coverage preferences of the plurality of BSs;
select a first BS of the plurality of BSs or a second BS of the plurality of BSs based on the GNSS information of the aircraft UE, the FL information of the aircraft UE, the projected trajectory of the aircraft UE, respective GNSS information of the selected BS, or a respective coverage preference of the selected BS; and
establish a wireless connection with the selected BS.

18. The non-transitory computer readable medium of claim 17, wherein the instructions for receiving further comprising instructions, when executed by the one or more processors, cause the one or more processors to:
receive the GNSS information of the plurality of BSs or a preference of the plurality of BSs via system information.

19. The non-transitory computer readable medium of claim 17, wherein the instructions for receiving further comprising instructions, when executed by the one or more processors, cause the one or more processors to:
receive the GNSS information of the plurality of BSs or a preference of the plurality of BSs via a MSG-B of a 2-step random access channel (RACH) procedure or a MSG-2 of a 4-step RACH procedure.

20. The non-transitory computer readable medium of claim 17, wherein the instructions for receiving further comprising instructions, when executed by the one or more processors, cause the one or more processors to:
obtain the GNSS information of the plurality of BS s or a preference of the plurality of BSs from a database associating one or more identifiers of the plurality of BSs and at least one of the respective GNSS information of the selected BS, or the respective preference of the selected BS.

21. The non-transitory computer readable medium of claim 17, wherein:
the FL information is obtained from an altimeter of the aircraft UE.

22. The non-transitory computer readable medium of claim 17, wherein:
the GNSS information of the plurality of BSs comprises geographic coordinates of the plurality of BSs or altitudes of the plurality of BSs.

23. The non-transitory computer readable medium of claim 17, wherein:
the preference comprises a threshold range for the aircraft UE to establish the wireless connection with the selected BS.

24. The non-transitory computer readable medium of claim 17, wherein:
the coverage preferences include at least one of GNSS coordinates or flight levels covered by at least one BS of the plurality of BSs.

25. A method of wireless communication by an aircraft user equipment (UE) in a network, comprising:
establishing a first connection with a first base station (BS) in a heterogeneous network (HetNet) for uplink transmission;
establishing a second connection with a second BS in the HetNet for downlink reception; and
computing a timing advance value based on:
at least one of one or more downlink reference signals transmitted by the first BS, GNSS information of the first BS, GNSS information of the aircraft UE, or an offset between downlink frame and uplink frame of the first BS, or
at least one of one or more downlink reference signals transmitted by the first BS, a first GNSS frame offset, a second GNSS frame offset, or a UE-GNSS frame offset.

26. The method of claim 25, further comprising, prior to establishing the first connection and the second connection:
receiving, at the aircraft UE in an airspace, at least one of global navigation satellite system (GNSS) information of the aircraft UE, flight level (FL) information of the aircraft UE, a projected trajectory of the aircraft UE, GNSS information of a plurality of base stations (BSs) in a heterogeneous network (HetNet), or a preference of the plurality of BSs; and
selecting the first BS and the second BS of the plurality of BSs or a second BS of the plurality of BSs based on the GNSS information of the aircraft UE, the FL information of the aircraft UE, the projected trajectory of the aircraft UE, respective GNSS information of the selected BS, or respective preferences of the selected BSs.

27. The method of claim 25, further comprising:
receiving configuration information indicating the first BS for the uplink transmission and the second BS for the downlink transmission.

28. The method of claim 25, further comprising:
receiving configuration information indicating a starting frame of the uplink frame relative to at least one of the one or more downlink reference signals.
